(19) United States
(12) Patent Application Publication
(10) Pub. No.: US 2024/0121022 A1
(43) Pub. Date: Apr. 11, 2024

(54) OPTICAL TRANSMISSION SYSTEM, WAVELENGTH CONVERTER, AND OPTICAL TRANSMISSION DEVICE

(71) Applicant: Fujitsu Limited, Kawasaki-shi (JP)

(72) Inventors: Hiroyuki IRIE, Kawasaki (JP); Hisao NAKASHIMA, Kawasaki (JP)

(73) Assignee: Fujitsu Limited, Kawasaki-shi (JP)

(21) Appl. No.: 18/229,478

(22) Filed: Aug. 2, 2023

(30) Foreign Application Priority Data
Oct. 5, 2022 (JP) 2022-160923

(51) Int. Cl. H04J 14/02; H04B 10/572

(52) U.S. Cl. CPC H04J 14/0221; H04B 10/572

(57) ABSTRACT

An optical transmission system includes: a WDM transmission device configured to output WDM signal light including rays of a plurality of wavelengths; a wavelength converter configured to convert the WDM signal light into converted light in a different wavelength band; and a processor configured to control a signal level of the WDM signal light incident on the wavelength converter, wherein the processor controls the signal level of the WDM signal light so as to make the signal level of the WDM signal light decrease in a direction away from a wavelength of pump light used in the wavelength converter.

### CROSS-REFERENCE TO RELATED APPLICATIONS

The present application is based upon and claims the benefit of priority of Japanese Patent Application No. 2022-160923 filed on Oct. 5, 2022, the entire contents of which are hereby incorporated by reference.

### FIELD

The present disclosure relates to an optical transmission system, a wavelength converter, and an optical transmission device.

### BACKGROUND

As one of the techniques for increasing the capacity of an optical communication network, wavelength division multiplexing (WDM) has been available. In a WDM transmission system, 96-channel signal transmission has been put into practical use in each of the C band of the 1550-nm band and the L band of the 1590-nm band. The S-band on the shorter wavelength side than the C-band has also been put into practical use. A transmission method using multiple communication bands is referred to as multi-band transmission. It is difficult to replace a transceiver used in a conventional C-band WDM transmission system with a multi-band transceiver from the viewpoint of development effort and cost. Therefore, a wavelength converter for converting a wavelength between the C band and the L band or between the C band and the S band is used.

As a method of wavelength conversion, four-wave mixing (FWM) that does not depend on a bit rate or a modulation scheme is adopted. By having two or more light rays of different angular frequencies incident on a nonlinear optical medium, a new light ray having an angular frequency different from any of the frequencies of the incident light rays is generated in the nonlinear optical medium. The newly generated light is referred to as idler light. By using this nonlinear optical effect, by having signal light and high-energy pump light incident on the nonlinear optical medium, converted light having a wavelength different from those of the incident signal light and the pump light can be generated.

### RELATED ART DOCUMENTS

### Patent Documents

Patent Document 1: Japanese Laid-Open Patent Application No. 2003-222917
Patent Document 2: Japanese Laid-Open Patent Application No. 2019-126487

The conversion efficiency of a wavelength converter using FWM has wavelength dependency. Even if a wavelength converter has a flat characteristic with respect to the wavelength of the light power of a WDM signal input into it, the SN ratio (SNR or Signal-to-Noise Ratio) of the idler light decreases in a wavelength region close to the pump light, and the transmission performance is limited.

### SUMMARY

According to an embodiment in the present disclosure, an optical transmission system includes: a WDM transmission device configured to output WDM signal light including rays of a plurality of wavelengths; a wavelength converter configured to convert the WDM signal light into converted light in a different wavelength band; and a processor configured to control a signal level of the WDM signal light incident on the wavelength converter, wherein the processor controls the signal level of the WDM signal light so as to make the signal level of the WDM signal light decrease in a direction away from a wavelength of pump light used in the wavelength converter.

The object and advantages of the invention will be realized and attained by means of the elements and combinations particularly pointed out in the claims. It is to be understood that both the foregoing general description and the following detailed description are exemplary and explanatory and are not restrictive to the invention as claimed.

### BRIEF DESCRIPTION OF DRAWINGS

FIG. 1 is a diagram illustrating SNR degradation of idler light in the vicinity of the wavelength of pump light;

FIG. 2 is a schematic diagram of an optical transmission system according to a first embodiment;

FIG. 3 is a diagram illustrating an example of a configuration of a wavelength converter;

FIG. 4 is a diagram illustrating an example of a control configuration of the signal level of incident WDM signal light;

FIG. 5 is a diagram illustrating another example of a control configuration of the signal level of incident WDM signal light;

FIG. 6 is a schematic diagram illustrating a modified example of a wavelength converter;

FIG. 7 is a schematic diagram illustrating another modified example of a wavelength converter;

FIG. 8 is a flow chart of signal level control of incident WDM signal light according to the first embodiment;

FIG. 9 is a schematic diagram of an optical transmission system according to a second embodiment;

FIG. 10 is a schematic diagram of a wavelength converter according to a second embodiment;

FIG. 11 is a flow chart of signal level control of incident WDM signal light according to the second embodiment;

FIG. 12 is a flow chart illustrating details of Step S21 in FIG. 11;

FIG. 13 is a diagram illustrating measurement positions of FWM noise light level on both sides of an idler light band;

FIG. 14 is a diagram illustrating a spectrum of idler light when no slope is set to the signal level of incident WDM signal light, as a comparative example;

FIG. 15 is a diagram illustrating the input power dependency of the SNR in the comparative example in FIG. 14;

FIG. 16 is a diagram illustrating an example of a slope set to input WDM signal light;

FIG. 17A is a diagram illustrating a FWM signal-to-noise ratio when different slopes are set to incident WDM signal light;

FIG. 17B is a diagram illustrating an amplified spontaneous emission (ASE) signal-to-noise ratio when different slopes are set to incident WDM signal light;

FIG. 17C is a diagram illustrating an effective signal-to-noise ratio when different slopes are set to incident WDM signal light;

FIG. 18 is a diagram illustrating a power spectrum of light involved in a wavelength conversion process in an embodiment; and

FIG. 19 is a diagram illustrating an effect obtained when a slope is set to input WDM signal light.

### DESCRIPTION OF EMBODIMENTS

According to embodiments, the transmission performance is improved in an optical transmission system using wavelength conversion. In an embodiment, the transmission performance of an optical transmission system including wavelength conversion is improved by controlling the signal level of WDM signal light incident on a nonlinear optical medium of a wavelength converter. Specifically, by controlling the signal level of the WDM signal light so as to decrease in a direction away from the wavelength of the pump light, the average effective SNR over the entire wavelength band of the idler light, i.e., the converted light, is maintained to be high. The signal level of the WDM signal light is the power level of the center wavelength of each channel included in the WDM signal light.

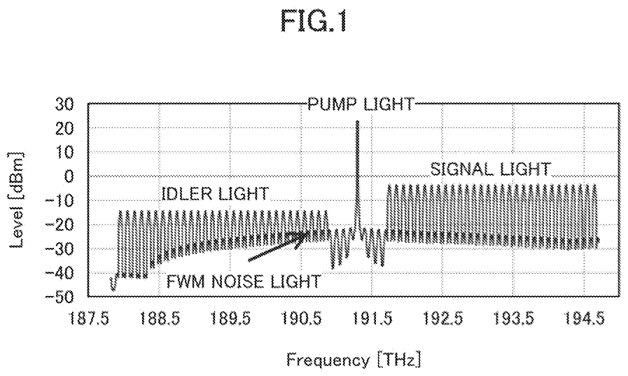

FIG. 1 illustrates a problem found by the inventors, i.e., SNR degradation of idler light in the vicinity of the wavelength of pump light. When signal light and the pump light having a sufficient intensity are incident on a nonlinear optical medium, nonlinear (second order or higher) polarization occurs inside the nonlinear optical medium with respect to an incident electric field, and a frequency component different from that of the incident light is generated from vibration of the polarization. The characteristic with respect to the wavelength or frequency of the incident WDM signal light power is flat. In contrast to that, in the idler light generated by the FWM, the ratio of the FWM noise increases in a wavelength component in the vicinity of the wavelength of the pump light.

Noise generated during the course of FWM includes noise due to interaction between wavelength components included in the incident WDM signal light, and noise due to interaction between the WDM signal light and the pump light. These noises associated with FWM are collectively referred to as FWM noise. In FIG. 1, in order to make the FWM noise easily recognizable, the layout is adjusted so that the FWM noise appears between the frequencies of the idler light.

In general, idler light generated by the nonlinear optical effect is extracted by an optical filter and amplified by an optical amplifier. Therefore, the wavelength conversion is accompanied by noise due to amplified spontaneous emission (ASE) light in addition to the FWM noise. Here, an effective SNR is introduced as an index for evaluating the transmission performance of a wavelength converter. The effective SNR is defined as follows:
FWM_SNR: power ratio of idler light to FWM noise
ASE_SNR: power ratio of idler light to ASE noise generated in an optical amplifier
Effective SNR: composite SNR of FWM_SNR and ASE_SNR

As illustrated in FIG. 1, in the case where the signal level of the input WDM signal light is flat with respect to the wavelength, large FWM noise is generated at wavelengths of the idler light in the vicinity of the wavelength of the pump light. FWM_SNR is low in the vicinity of the wavelength of the pump light, and are higher as further away from the wavelength of the pump light. On the other hand, the signal level of the idler light input into the optical amplifier is flat with respect to the wavelength; therefore, the ASE noise generated in the optical amplifier is substantially the same over the entire wavelength band of the idler light, and ASE_SNR is constant. As a result, the effective SNR of the idler light decreases at a wavelength close to the wavelength of the pump light, and the transmission performance is limited.

In an embodiment, the effective SNR of idler light is improved as a whole by controlling WDM signal light so that the signal level of the WDM signal light incident on a nonlinear optical medium becomes lower in a direction away from the wavelength of the pump light. In the following embodiments, in some cases, the same components are denoted by the same reference numerals to avoid repetition of redundant description. As the wavelength is the reciprocal of the frequency, it is assumed that the term “wavelength” also includes the meaning of “frequency”.

### First Embodiment

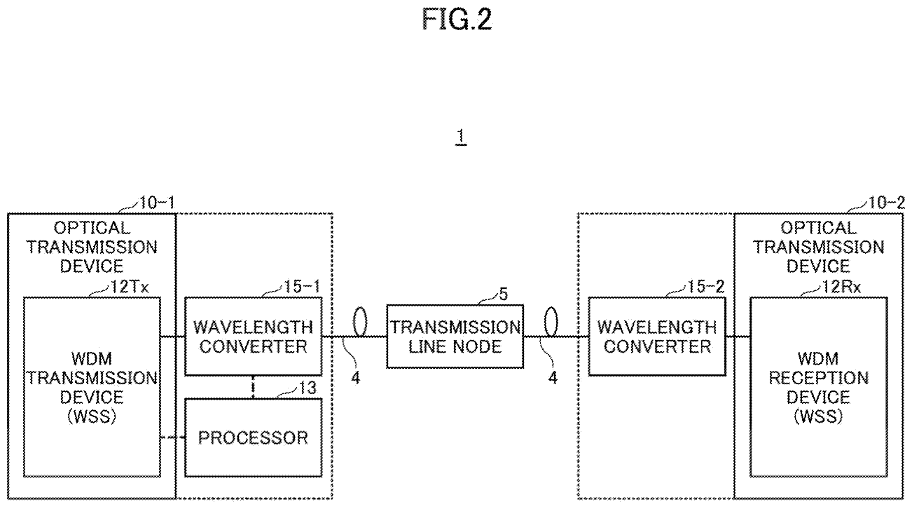

FIG. 2 is a schematic diagram of an optical transmission system 1 according to a first embodiment. An optical transmission system 1 includes a wavelength converter 15-1 provided at the optical output stage of an optical transmission device 10-1, and a wavelength converter 15-2 provided at the optical input stage of an optical transmission device 10-2. In the first embodiment, the wavelength band of WDM signal light to which wavelength conversion is applied by the wavelength converter 15-1 is known, and the optical transmission device 10-1 and the wavelength converter 15-1 are linked. An electric control signal can be transmitted and received between the optical transmission device 10-1 and the wavelength converter 15-1 as necessary, and the optical transmission device 10-1 controls the signal level of each wavelength of the WDM signal light incident on the wavelength converter 15-1. A thick dashed line in FIG. 2 indicates an electric control line. As indicated by a dotted line block, the wavelength converter 15-1 may be embedded in the optical transmission device 10-1 and arranged at the light emission end of the optical transmission device 10-1.

The optical transmission device 10-1 includes a WDM transmission device 12Tx. The WDM transmission device 12Tx and the wavelength converter 15-1 are connected by an optical path such as an optical fiber. As will be described later, the signal level of the WDM signal light incident on the wavelength converter 15-1 is controlled by a processor 13. The processor 13 may be provided inside the WDM transmission device 12Tx, or may be provided inside the wavelength converter 15-1. In the case where the wavelength converter 15-1 is embedded in the optical transmission device 10-1, the processor 13 may be electrically connected to the WDM transmission device 12Tx and the wavelength converter 15-1 inside the optical transmission device 10-1. A wavelength selective switch (WSS) may be provided in the optical transmission device 10-1.

The optical transmission device 10-1 and the optical transmission device 10-2 are connected by a transmission line 4. A transmission line node such as a relay amplifier, an optical add-drop multiplexer (OADM), or the like may be inserted on the transmission line 4. The wavelength converters 15-1 and 15-2 have the same configuration. The wavelength converter 15-1 and the wavelength converter 15-2 are in a mirror relationship with respect to the transmission line 4. WDM signals in the C-band output from the WDM transmission device 12Tx are collectively converted into, for example, WDM signals in the L-band by the wavelength converter 15-1, and transmitted to the transmission line 4. The WDM signals in the L-band incident on the wavelength converter 15-2 from the transmission line 4 are collectively converted into WDM signals in the C-band by the wavelength converter 15-2 and received by the WDM receiving device 12Rx.

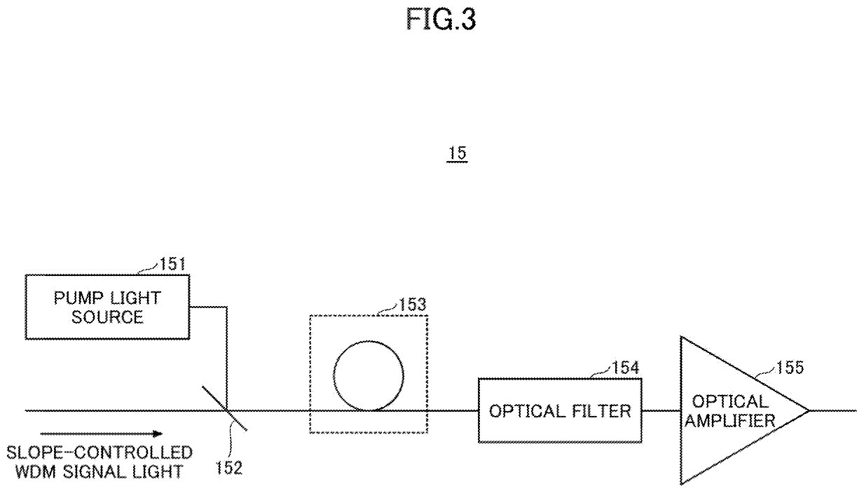

As one of the features of the optical transmission system 1, the signal level of the WDM signal light incident on the wavelength converter 15-1 is controlled to decrease in a direction away from the wavelength of the pump light used in the wavelength converter 15-1. For the sake of convenience, this control of the signal level is referred to as “slope control” of the signal level. The slope control of the signal level of the WDM signal light is executed by the processor 13 as described above. The “slope control” of the signal level is an example, and the processor 13 may execute another control for adjusting the wavelength-loss characteristic, as long as the effective SNR can be maintained over the wavelength band of the converted light. As long as the slope or the wavelength-loss characteristic of the signal level of the WDM signal light incident on the wavelength converter 15-1 can be controlled, the processor 13 may be arranged at any position. FIG. 3 is a schematic diagram of the wavelength converter 15. The wavelength converter includes a pump light source 151, a multiplexer 152, a nonlinear optical medium 153, an optical filter 154, and an optical amplifier 155. The pump light emitted from the pump light source 151 is multiplexed with the WDM signal light whose signal level is slope-controlled by the multiplexer 152, and incident on the nonlinear optical medium 153. The multiplexer 152 is, for example, an optical fiber coupler.

As the nonlinear optical medium 153, a highly nonlinear (HNL) fiber having high consistency with an optical fiber may be used. The optical filter 154 passes the idler light (converted light) generated in the nonlinear optical medium 153, and blocks the WDM signal light and the pump light. The optical amplifier 155 amplifies and outputs the idler light. The light output from the optical amplifier 155 includes FWM noise generated during the course of a nonlinear optical process and ASE noise generated in the optical amplifier 155. In an embodiment, by reducing the FWM noise included in the idler light particularly in the vicinity of the wavelength of the pump light, the effective SNR of the idler light is improved as a whole. The effective SNR is a composite SNR of the SNR for the FWM noise and the SNR for the ASE noise.

### <Control of Signal Level of Incident WDM Signal Light>

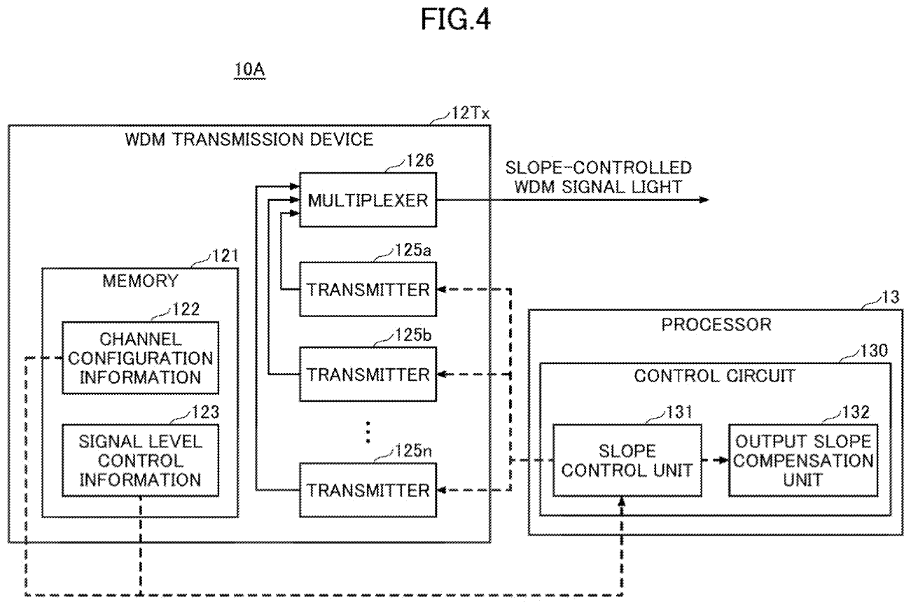

FIG. 4 illustrates an example of a configuration for controlling the signal level of the WDM signal light incident on the nonlinear optical medium 153, in an optical transmission device 10A. In FIG. 4, the signal level of each wavelength of the WDM signal light is adjusted using the output adjustment function of transmitters 125a, 125b, . . . , 125n (collectively referred to as the “transmitter(s) 125” as appropriate, hereafter) connected to the WDM transmission device 12Tx. The output adjustment function of the transmitter 125 may be, for example, a pre-emphasis function. The transmitters 125a to 125n are transmission units of multiple transponders that handle optical signals of wavelengths different from each other. By adjusting the output power of the transmitters 125a, 125b, . . . , 125n, the signal level of the multiplexed WDM signal light can be controlled to a desired wavelength-loss characteristic. For example, a desired slope can be set to the level of the WDM signal light.

A control circuit 130 is implemented by the processor 13. The processor 13 includes a slope control unit 131 as its functional block. A thick dashed line in FIG. 4 indicates an electric control line. Depending on the configuration of the wavelength converter 15, the control circuit 130 may be provided with an output slope compensation unit 132. The processor 13 may be provided in the WDM transmission device 12Tx, may be provided in the wavelength converter 15, or may be provided somewhere in the optical transmission device 10A. The control circuit 130 refers to channel configuration information 122 and signal level control information 123 stored in a memory 121, controls the output power of each transmitter 125, and sets a slope in the wavelength direction to the signal level of the WDM signal light. The memory 121 may be provided in the WDM transmission device 12Tx, may be embedded in the processor 13, or may be provided somewhere in the optical transmission device 10A.

The channel configuration information 122 includes information on the wavelength band of each channel. In the case where the band before wavelength conversion is the C band, information on the center wavelengths of the respective channels provided in a band of wavelengths from 1530 nm to 1565 nm at intervals of, for example, 50 GHz is stored as the information on the wavelength band. Identification information on transponders or transmitters 125 corresponding the respective center wavelengths may be included in the channel configuration information 122. The signal level control information 123 includes information on the slope in the wavelength direction set to the signal level of the WDM signal light.

The signal level control information 123 is determined by changing the slope in the wavelength direction of the signal level of the WDM signal light incident on the wavelength converter 15, and calculating a slope in the case where the average effective SNR becomes the highest over the entire wavelength band of the idler light. The signal level of each wavelength of the incident WDM signal light is set so that the effective SNR obtained by adding FWM_SNR and ASE_SNR is the highest over the entire wavelength band of the idler light.

When the signal level of the WDM signal light incident on the wavelength converter 15 is controlled to lower the signal level in a direction away from the wavelength of the pump light, the following results are obtained.
(1) FWM noise is reduced at a wavelength of the idler light close to the wavelength of the pump light, and FWM_SNR is improved.
(2) The signal level of the idler light far from the wavelength of the pump light is lowered; therefore, ASE_SNR of the idler light output from the optical amplifier 155 is lowered.

The above (1) and (2) are in a trade-off relationship. In order to obtain a wavelength-loss characteristic in which (1) and (2) are balanced, the slope with which the average effective SNR of the idler light becomes the highest as a whole is set to the signal level of incident WDM signal light. Accordingly, the transmission performance of the optical transmission system 1 is improved. The signal level control information 123 and the channel configuration information 122 may be input into the memory 121 in advance, for example, by an operator. The slope control unit 131 of the control circuit 130 supplies a control value to each transmitter 125a, 125b, . . . , 125n, based on the band information on each channel included in the channel configuration information 122 and the set signal level of each channel included in the signal level control information 123. Each of the transmitters 125a, 125b, . . . , 125n adjusts the power of an optical signal to be output based on the control value.

Light rays of the respective wavelengths output from the transmitters 125a, 125b, . . . , 125n are multiplexed by the multiplexer 126 to generate WDM signal light. The signal level of this WDM signal light has a predetermined slope in the wavelength direction. The WDM signal light whose signal level is slope-controlled is guided to the wavelength converter 15, and incident on the nonlinear optical medium 153 together with the pump light.

In the case where the output slope compensation unit 132 is provided in the control circuit 130, the output slope compensation unit 132 sets a slope in a direction opposite to the slope set to the incident WDM signal light, to the idler light (converted light) output from the optical amplifier 155 of the wavelength converter 15. By the slope set to the signal level of the incident WDM signal light, the signal level becomes lower at a wavelength further away from the pump light, and a slope is also generated in the power spectrum of the generated idler light. The output slope compensation unit 132 may control the wavelength converter 15 so as to compensate for a decrease in power in the wavelength direction that occurs in the idler light.

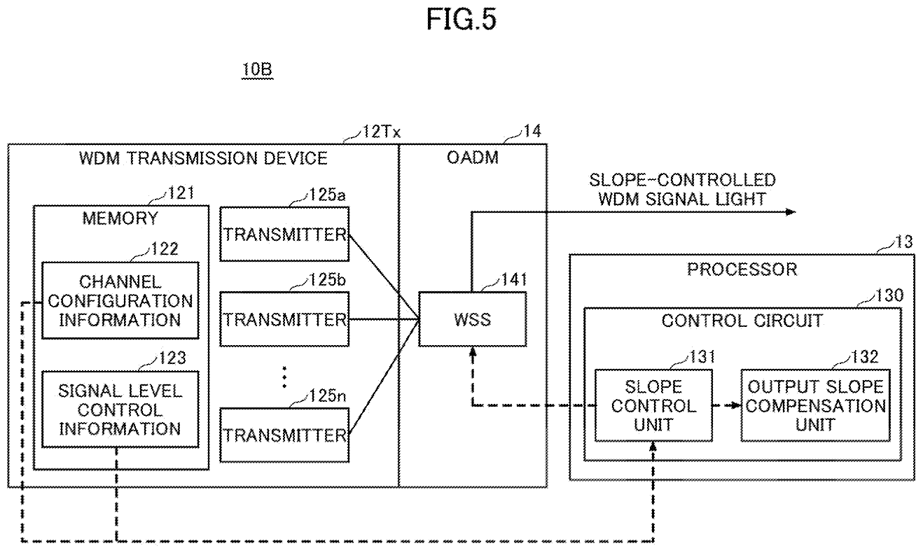

FIG. 5 illustrates another configuration example of spectrum control of WDM signal light incident on the nonlinear optical medium 153, in an optical transmission device 10B. In FIG. 5, the power adjustment function of the optical transmission device 10B is used for controlling the signal level of the WDM signal light incident on the wavelength converter 15. The power adjustment function of the optical transmission device 10B is implemented by, for example, an attenuator of a WSS 141, a gain adjuster of a gain equalizer, a waveform shaper, or the like of an optical add-drop multiplexer (denoted as “OADM” in the FIG. 14. In the example in FIG. 5, the attenuator of the WSS 141 is used for controlling the signal level of the WDM signal light. A thick dashed line in FIG. 5 indicates an electric control line.

Light rays of the respective wavelengths output from the multiple transmitters 125a, 125b, . . . , 125n are incident on the WSS 141. The slope control unit 131 of the control circuit 130 outputs a control signal to the WSS 141 with reference to the channel configuration information 122 and the signal level control information 123 stored in a memory 121. The memory 121 may be provided in the WDM transmission device 12Tx, may be embedded in the processor 13, or may be provided somewhere in the optical transmission device 10B.

The WSS 141 adjusts the power of the WDM signal light for each channel based on the control signal from the control circuit 130. The WDM signal light having passed through the WSS 141 is incident on the nonlinear optical medium 153 of the wavelength converter 15 together with the pump light, as the WDM signal light whose signal level is slope-controlled in the wavelength direction.

In the case where the output slope compensation unit 132 is provided in the control circuit 130, the output slope compensation unit 132 sets a slope in a direction opposite to the slope of the signal level set to the WDM signal light, to the idler light (converted light) output from the optical amplifier 155 of the wavelength converter 15. Accordingly, a decrease in power in the wavelength direction occurring in the idler light is compensated.

<Modified Example of Wavelength Converter>

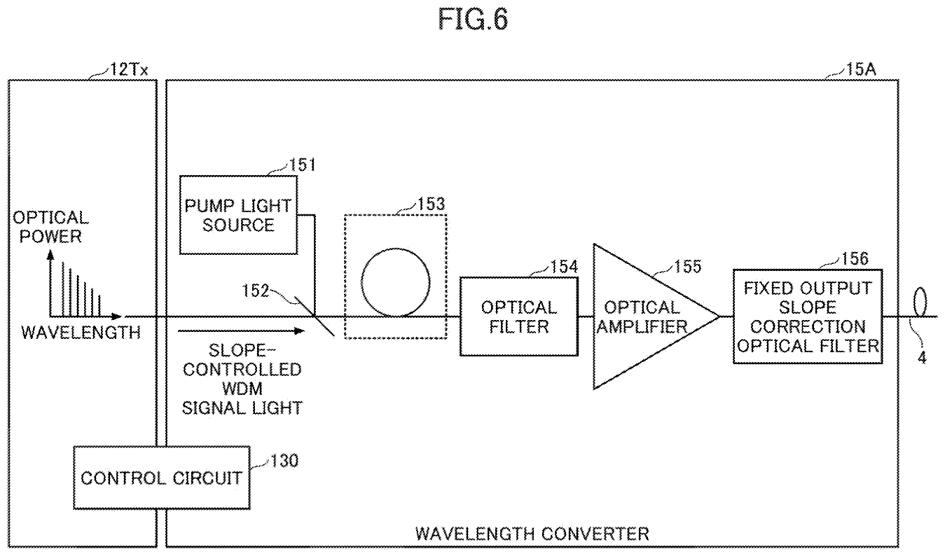

FIG. 6 is a diagram schematically illustrating a wavelength converter 15A, which is a modified example of the wavelength converter 15. The signal level of the WDM signal light incident on the wavelength converter 15A is slope-controlled by the control circuit 130. The control circuit 130 may be provided inside the WDM transmission device 12Tx, or may be provided inside the wavelength converter 15A. The WDM signal light whose signal level is controlled in the wavelength direction is multiplexed by the multiplexer 152 with the pump light emitted from the pump light source 151, and is incident on the nonlinear optical medium 153. The idler light generated in the nonlinear optical medium 153 is extracted by the optical filter 154 and amplified by the optical amplifier 155.

The wavelength converter 15A includes a fixed output slope correction optical filter 156 at the output stage of the optical amplifier 155. The correction value of the fixed output slope correction optical filter 156, i.e., the adjustment value of the wavelength-loss characteristic is fixed, and, for example, a fixed slope is set for correcting the power level of the idler light to be flat in the wavelength direction. The wavelength converter 15A having this configuration is used when the wavelength band of the WDM signal light to which wavelength conversion is applied is fixed. The output slope compensation unit 132 is not required in the control circuit 130.

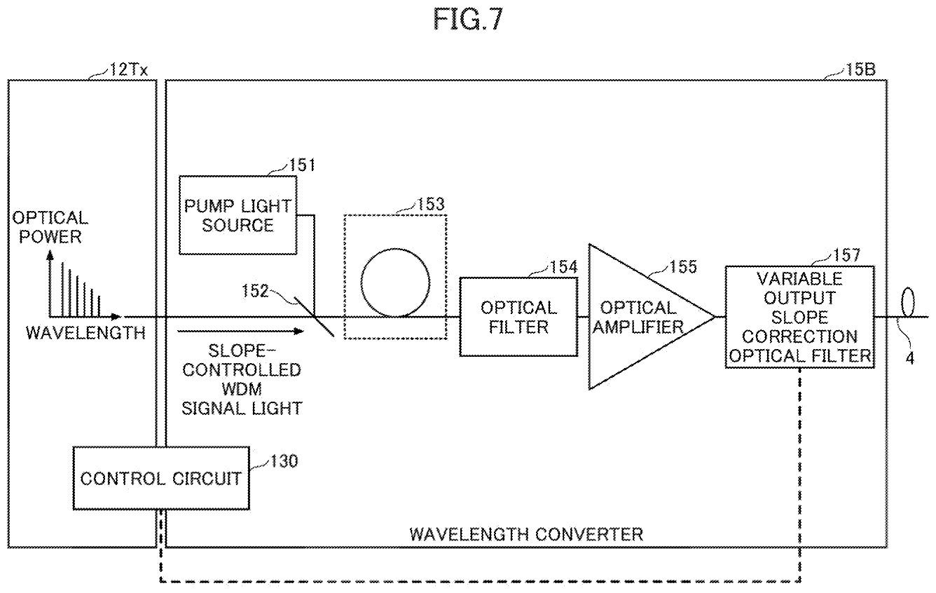

FIG. 7 is a diagram schematically illustrating a wavelength converter 15B, which is another modified example of the wavelength converter 15. A thick dashed line in FIG. 7 indicates an electric control line. The wavelength converter 15B includes a variable output slope correction optical filter 157 at the output stage of the optical amplifier 155. The correction value of the output slope correction, i.e., the wavelength-loss characteristic, is variably set based on the control signal supplied from the control circuit 130. The wavelength converter 15B having this configuration is used when the wavelength band of the WDM signal light to which wavelength conversion is applied is not fixed.

The output slope compensation unit 132 of the control circuit 130 refers to the channel configuration information 122 and the signal level control information 123 in the memory 121 when the wavelength band of the WDM signal light input into the wavelength converter 15B changes, and sets a wavelength-loss characteristic required for the output-slope compensation in the variable output slope correction optical filter 157. Accordingly, the wavelength characteristic of the idler light power output from the optical amplifier 155 becomes flat.

### <Control Flow of First Embodiment>

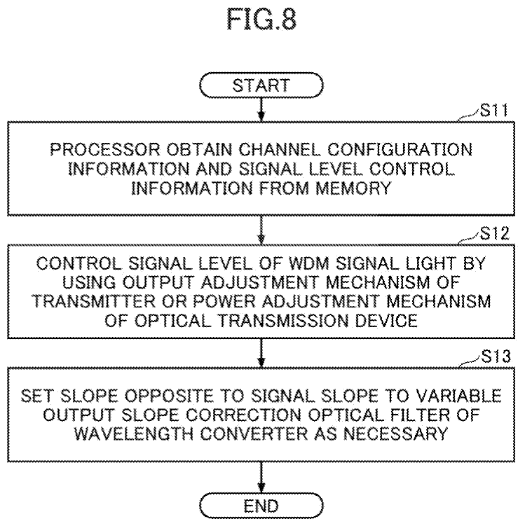

FIG. 8 is a flow chart of slope control of the incident WDM signal light according to the first embodiment. This control flow is executed by the processor 13. The processor 13 obtains the channel configuration information 122 and the signal level control information 123 from the memory 121 (Step S11). The channel configuration information 122 includes band information for each wavelength of the WDM signal light. The signal level control information 123 includes the signal level of each wavelength to be set to the WDM signal light, or the slope information in the wavelength direction of the signal level of the WDM signal light. Based on the obtained signal level control information, the processor 13 controls the signal level of each wavelength of the WDM signal light, by controlling the output adjustment mechanism of the transmitter 125 of the transponder, or the power adjustment mechanism of the optical transmission device 10 (Step S12). The power adjustment mechanism of the optical transmission device 10 is a variable attenuator of the WSS 141, a gain adjuster of the gain equalizer, a waveform shaper, or the like. By controlling the signal level of each wavelength of the WDM signal light, a slope in the wavelength direction is set to the signal level of the WDM signal light.

The processor 13 sets a slope opposite to the slope set to the WDM signal light to the variable output slope correction optical filter 157 provided at the output stage of the optical amplifier 155 of the wavelength converter 15 as necessary (Step S13). Accordingly, the average effective SNR is increased over the entire wavelength band of the idler light output from the wavelength converter 15, and the transmission performance is improved.

### Second Embodiment

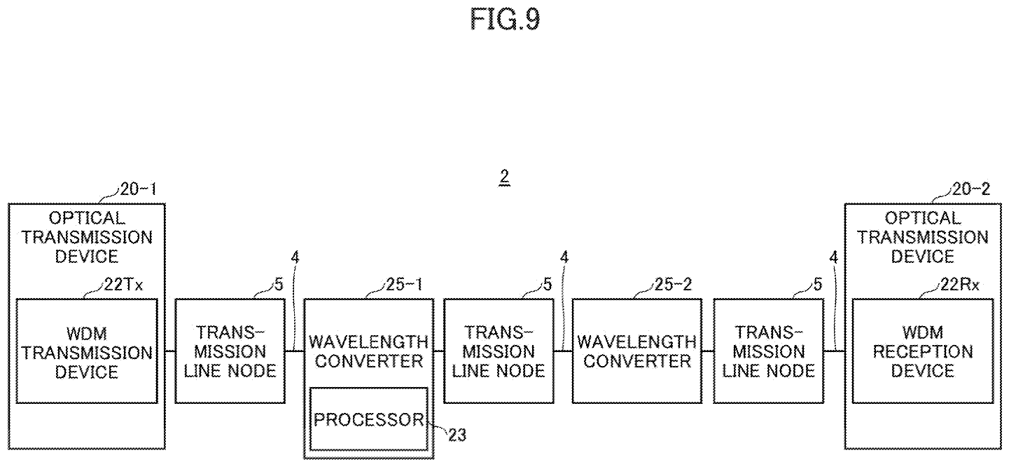

FIG. 9 is a schematic diagram of an optical transmission system 2 according to a second embodiment. In the second embodiment, wavelength converters 25-1 and 25-2 are not linked to optical transmission devices 20-1 and 20-2, and are placed in the middle of a transmission line 4. In this configuration, as an example of control of the wavelength-loss characteristic, the wavelength converter 25-1 controls the signal level of the WDM signal light incident on the nonlinear optical medium.

The optical transmission system 2 includes the optical transmission devices 20-1 and 20-2 connected by the transmission line 4, and the wavelength converters 25-1 and 25-2 arranged in the middle of the transmission line 4. Transmission line nodes 5 such as a relay amplifier, an OADM, and the like may be inserted on the transmission line 4. The wavelength converter 25-1 includes a processor 23, and controls the signal level of the WDM signal light incident from the transmission line 4 so as to become lower in a direction away from the wavelength of the pump light.

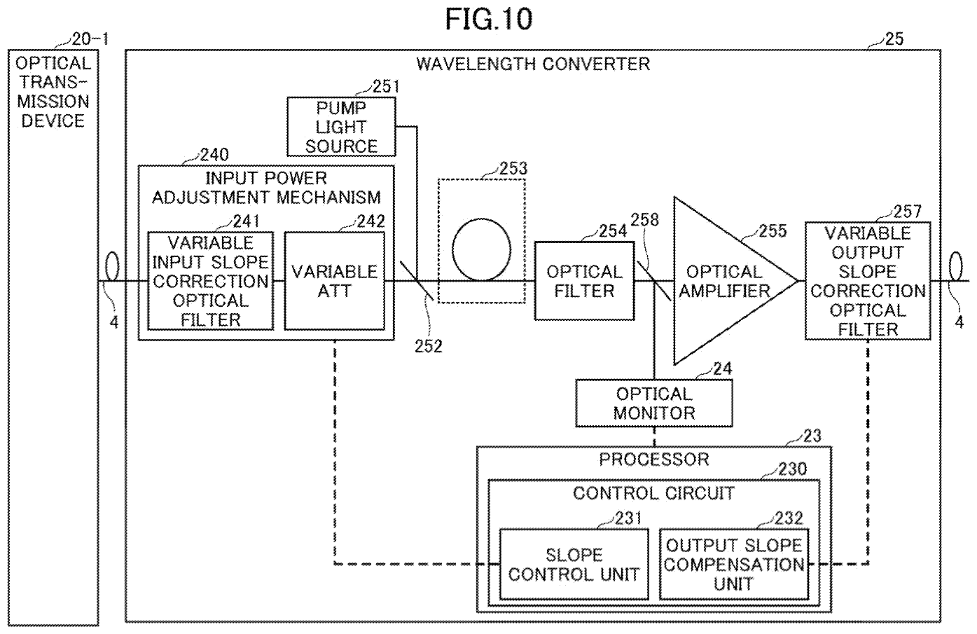

FIG. 10 is a schematic diagram of the wavelength converter 25 according to the second embodiment. A thick dashed line in FIG. 10 indicates an electric control line. In addition to the processor 23, the wavelength converter 25 includes a pump light source 251, a multiplexer 252, a nonlinear optical medium 253, an optical filter 254, a demultiplexer 258, an optical amplifier 255, an optical monitor 24, and an input power adjustment mechanism 240. Optionally, a variable output slope correction optical filter 257 may be connected to the output stage of the optical amplifier 255. A thick dashed line in the figure indicates an electric control line.

The processor 23 includes a control circuit 230. The control circuit 230 includes, as its functional units, a slope control unit 231 and optionally an output slope compensation unit 232. As described above, the slope of the signal level with respect to the wavelength is an example of the wavelength-loss characteristic. In the case where the variable output slope correction optical filter 257 is provided at the output stage of the optical amplifier 255, the wavelength-loss characteristic of the variable output slope correction optical filter 257 is set by the output slope compensation unit 232.

The input power adjustment mechanism 240 includes a variable input slope correction optical filter 241 and a variable attenuator (denoted as “ATT” in the FIG. 242. The variable input slope correction optical filter 241 adjusts the wavelength characteristic of the power of the WDM signal light incident on the wavelength converter 25 from the transmission line 4, and sets a slope in the wavelength direction to the signal level of incident WDM signal light. The variable attenuator 242 adjusts the optical power of the entire WDM signal light to which slope control is applied, to optimize the signal power of the WDM signal light as a whole.

The WDM signal light for which the slope of the signal level and the total power are optimized by the input power adjustment mechanism 240 is multiplexed by the multiplexer 252 with the pump light emitted from the pump light source 251. Once the WDM signal light and the pump light are incident on the nonlinear optical medium 253, idler light (converted light) is generated in the nonlinear optical medium 253 due to interaction between the incident optical waves. The idler light included in the light emitted from the nonlinear optical medium 253 is extracted by the optical filter 254, amplified by the optical amplifier 255, and transmitted to the transmission line 4. The wavelength characteristic of the power of the converted light is corrected to be flat by the variable output slope correction optical filter 257 as necessary.

Part of the output light of the optical filter 254 is branched by the demultiplexer 258, and the peak level of each wavelength included in the idler light and the FWM noise level are measured by the optical monitor 24. As the optical monitor 24, an optical spectrum analyzer, an optical channel monitor (OCM), or the like can be used. The monitoring result of the optical monitor 24 is input into the slope control unit 231 of the processor 23.

The slope control unit 231 calculates FWM_SNR and ASE_SNR generated in the optical amplifier 255 at the next stage from the monitoring result of the optical monitor 24. ASE_SNR is calculated by Formula (1) using the noise figure NF of the optical amplifier 255.

$$\begin{matrix}[ Math . 1 ] & \\ ASE\_SNR = \frac{{P}_{Idler}}{NF \cdot hv \cdot B} & ( 1 )\end{matrix}$$

where P_{Idler} is the peak power of the idler light, h is Planck's constant, v is the vibration frequency of the idler light, and B is the signal bandwidth of the idler light.

The slope control unit 231 combines FWM_SNR and ASE_SNR for each wavelength to obtain the slope of the effective SNR. In addition, a slope opposite to the slope of the effective SNR of the idler light is supplied to the input power adjustment mechanism 240 as control information. Based on the control information, the input power adjustment mechanism 240 adjusts the slope in the wavelength direction of the signal level of the WDM signal light incident from the transmission line 4, and the power level of the entire WDM signal light. In the case where the band handled by the wavelength converter 25 is fixed, the optical monitor 24 and the control circuit 230 may be omitted. In this case, instead of the variable input slope correction optical filter 241 and the variable output slope correction optical filter 257, a fixed input slope correction optical filter and a fixed output slope correction optical filter may be provided.

### <Control Flow of Second Embodiment>

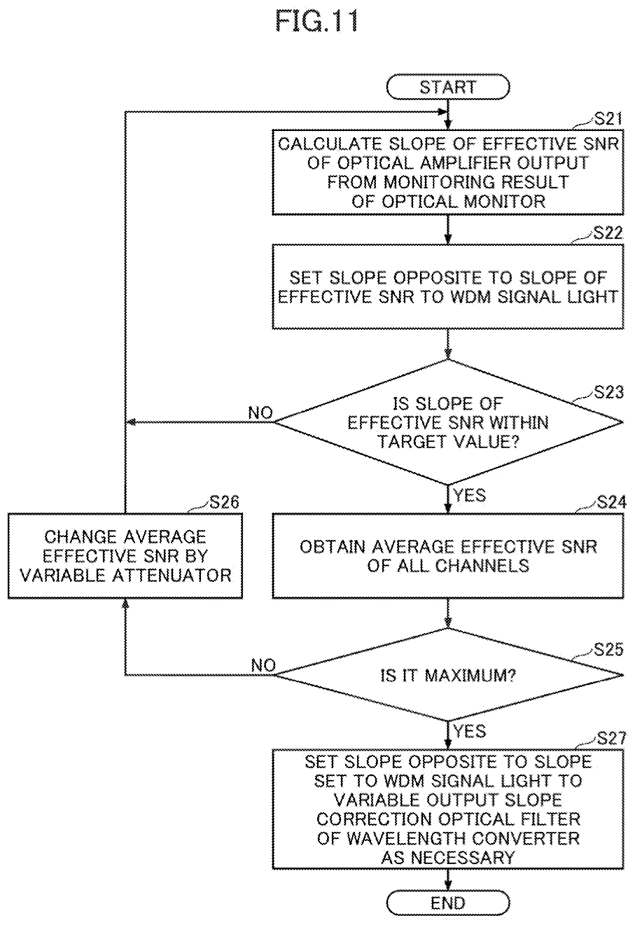

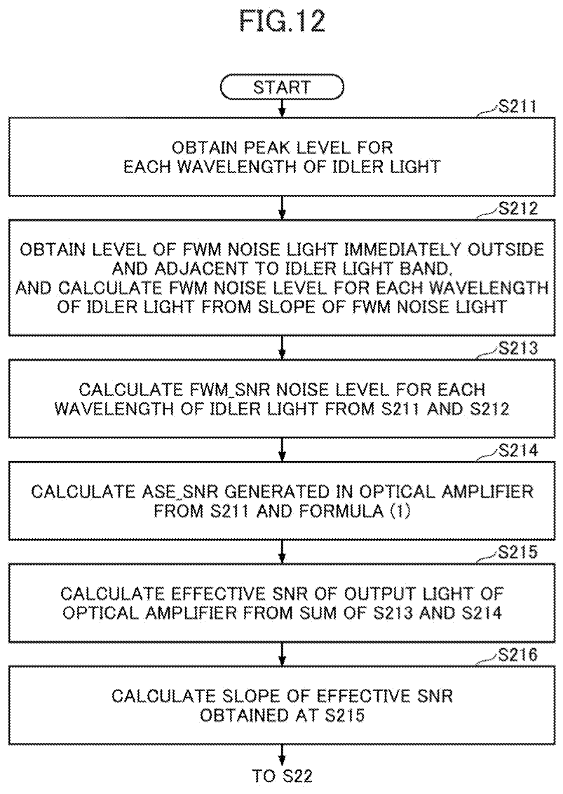

FIG. 11 is a flow chart of slope control of the incident WDM signal light according to the second embodiment. This control flow is executed by the processor 23. Based on the monitoring result of the optical monitor 24, the processor 23 calculates the slope of the effective SNR of the light output from the optical amplifier 255 (Step S21). A specific method of calculating the effective SNR of the output light of the optical amplifier 255 and its slope will be described later with reference to FIG. 12.

A slope opposite to the slope of the effective SNR obtained at Step S21 is set to the power spectrum of the incident WDM signal light (Step S22). Next, it is determined whether the slope of the effective SNR is within the target value (Step S23). If the slope of the effective SNR exceeds the target value by too large an amount, there is a likelihood that the power of the idler light decreases at a wavelength far from the wavelength of the pump light, and ASE_SNR of the output light of the optical amplifier 255 decreases. Therefore, if the slope of the effective SNR exceeds the target value (NO at Step S23), the process returns to Step S21 to monitor part of the idler light output from the optical filter 254, and recalculates the slope of the effective SNR of the light output from the optical amplifier 255. Steps S21 and S22 are repeated until the slope of the effective SNR of the incident WDM signal light is within the target value (YES at Step S23).

Once the slope of the effective SNR of the incident WDM signal light falls within the target value, the average effective SNR of all channels is obtained (Step S24), and it is determined whether the average effective SNR is maximum (Step S25). If the average effective SNR is not the maximum (NO at Step S25), it means that the optimum effective SNR is not obtained for the idler light as a whole. In this case, at Step S26, the variable attenuator 242 is controlled to increase the power of the entire incident WDM signal light by a predetermined step size, and Steps S21 to S25 are repeated.

If the average effective SNR of all the channels of the idler light is maximum (YES at Step S25), it means that the slope and the average power of the incident WDM signal light are set appropriately. If necessary, a slope opposite to the slope set to the incident WDM signal light may be set by controlling the wavelength-loss characteristic of the variable output slope correction optical filter 257 connected to the output stage of the optical amplifier 255 (Step S27). Accordingly, the power level of the idler light output from the wavelength converter 25 becomes flat in the wavelength direction.

FIG. 12 is a detailed processing flow of Step S21 in FIG. 11. The processor 23 obtains the peak level for each wavelength of the idler light from the monitoring result by the optical monitor 24 (Step S211). As described above, the optical monitor 24 is a monitor device capable of measuring the peak power for each channel, which is an optical spectrum analyzer, an OCM, or the like. Further, the level of FWM noise light immediately outside and adjacent to the idler light band is obtained, and the FWM noise level of each wavelength of the idler light is calculated from the slope of the FWM noise light (Step S212).

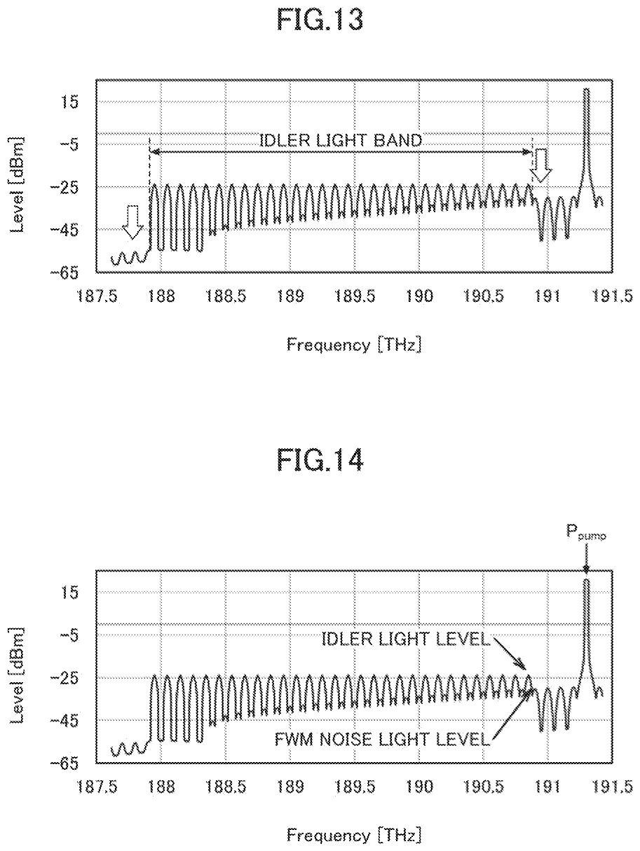

FIG. 13 illustrates measurement positions of the FWM noise light immediately outside the idler light band. The measurement positions of the FWM noise light are indicated by white arrows. By obtaining the levels of the FWM noise light at the positions adjacent to both ends of the idler light band, the slope of the FWM noise in the entire idler light band is obtained. The FWM noise of each wavelength of the idler light is obtained from the slope of the FWM noise. FWM_SNR of the WDM signal light incident on the optical amplifier 255 is obtained from the peak levels of the respective wavelengths of the idler light obtained at Step S211, and the FWM noise levels of the respective wavelengths of the idler light obtained at Step S212 (Step S213).

The processor 23 further calculates ASE_SNR of the light output from the optical amplifier 255 for each channel, from the peak levels of the respective wavelengths of the idler light obtained at Step S211 and the ASE noise obtained by the above Formula (1) (Step S214). The effective SNR of each wavelength included in the light output from the optical amplifier 255 is calculated from the sum of FWM_SNR obtained at Step S213 and ASE_SNR obtained at Step S214 (Step S215). The slope of the effective SNR obtained at Step S215 is calculated, and the process proceeds to Step S22 in FIG. 11. Accordingly, in the case where the wavelength converter 25 is arranged in the middle of the transmission line 4 without being linked to the optical transmission device 20, decrease in the effective SNR of the entire idler light can be suppressed, and the transmission performance can be improved.

### <Verification of Effects>

FIG. 14 illustrates, as a comparative example, a spectrum diagram of idler light when no slope in the wavelength direction is set to the signal level of incident WDM signal light. At a wavelength of the idler light close to the wavelength of the pump light Ppump, the ratio of the FWM noise light to the peak wavelength is large, and FWM_SNR becomes minimum.

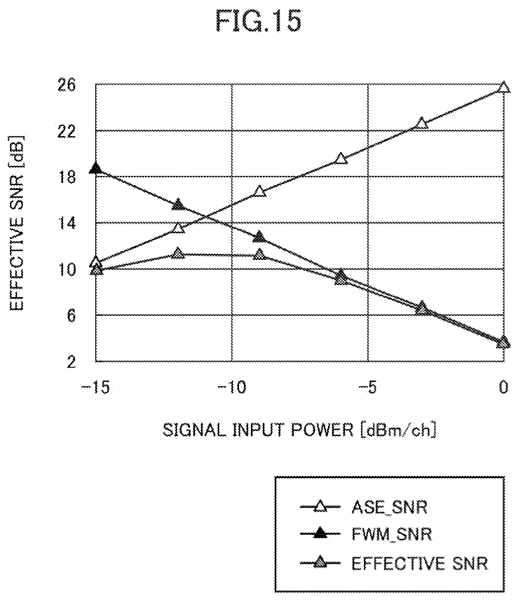

FIG. 15 illustrates the signal input power dependency in a comparative example, i.e., when no slope is set to the incident WDM signal light. The horizontal axis represents the average signal input power per channel. The effective SNR is calculated from ASE_SNR and FWM_SNR while changing the average signal input power of the WDM signal light. ASE_SNR is calculated by Formula (1) based on the peak power in FIG. 14. When the average input power of the WDM signal light is smaller, ASE_SNR decreases, whereas the FWM noise decreases and FWM_SNR increases. The effective SNR, which is a composite of FWM_SNR and ASE_SNR, becomes maximum when the average input power per channel of the WDM signal light is −11 dBm/ch. The effective SNR at that time is 11.3 dB. Even if increasing the average input power from −11 dBm/ch, the effective SNR decreases. In the case where the slope is not set to the incident WDM signal light as in the comparative example, the upper limit of the effective SNR of the idler light is limited, and the transmission performance deteriorates.

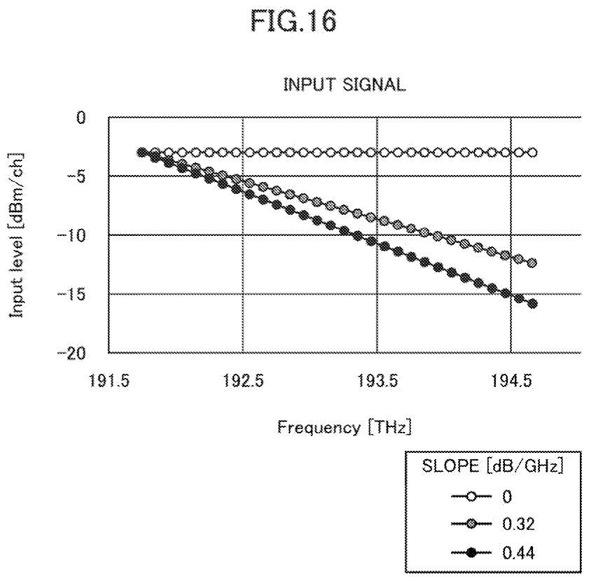

FIG. 16 illustrates an example of a slope set to a signal level of incident WDM signal light in an application example. The horizontal axis represents the frequency, and the vertical axis represents the input level. When the slope set to the signal level of incident WDM signal light is 0 dB/100 GHz, the wavelength-frequency characteristic of the power of the incident WDM signal light is flat as in the comparative example. In this case, as illustrated in FIG. 14, the FWM noise ratio of the idler light close to the wavelength of the pump light increases, and even if the average power of the incident WDM signal light is increased, the effective SNR is limited as illustrated in FIG. 15. An optimum slope amount that solves the limitation of the effective SNR to maintain a high effective SNR over the entire band of idler light is investigated as follows.

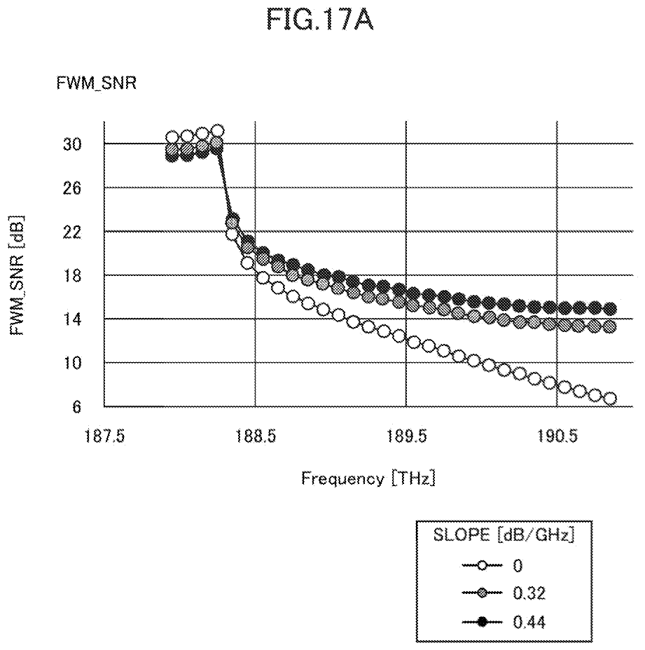

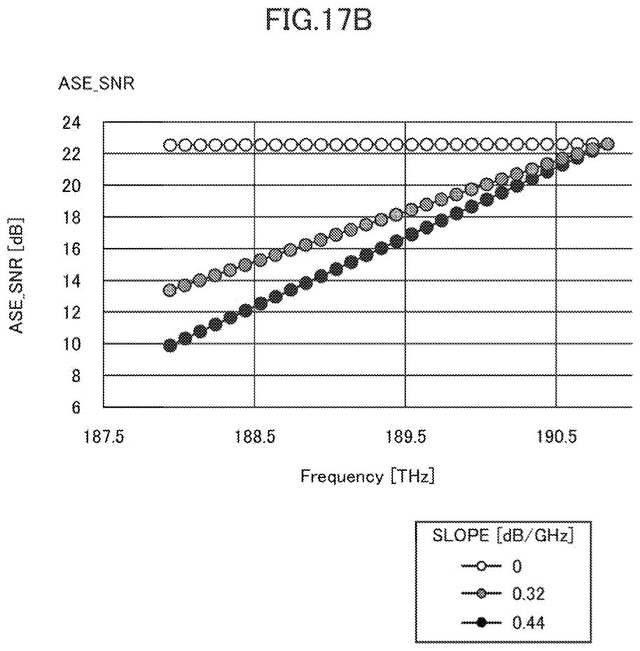

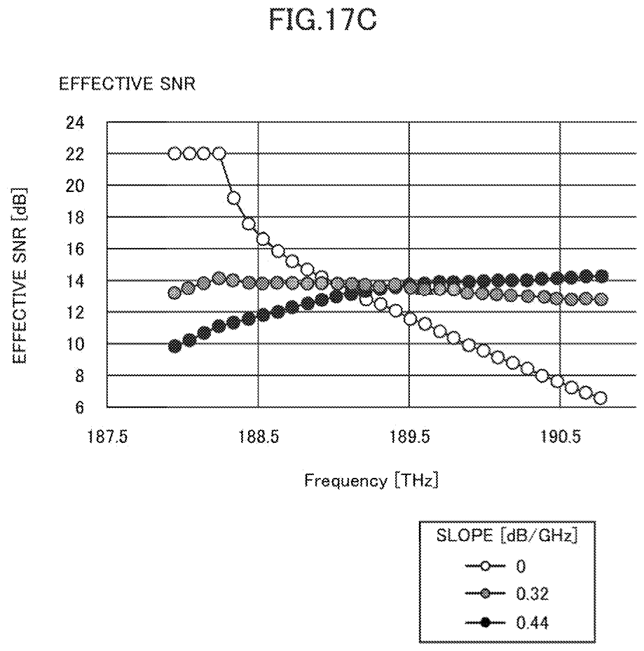

FIG. 17A illustrates FWM_SNR when different slopes are set to the signal level of incident WDM signal light in the application example. FIG. 17B illustrates ASE_SNR when different slopes are set to the signal level of incident WDM signal light in the application example. FIG. 17C illustrates effective SNR when different slopes are set to the signal level of incident WDM signal light in the application example. In FIGS. 17A to 17C, the amount of slope set to the incident WDM signal light is changed to 0 dB/100 GHz, 0.32 dB/100 GHz, and 0.44 dB/GHz.

In FIG. 17A, there is no significant difference in FWM_SNR between when the slope of the incident WDM signal light is 0.44 dB/100 GHz and when it is 0.32 dB/100 GHz. In FIG. 17B, when the slope is 0.44 dB/100 GHz, decrease in ASE_SNR becomes significant on the longer wavelength side (lower frequency side). By combining FWM_SNR and ASE_SNR, the effective SNR in FIG. 17C is obtained. When the slope is 0.32 dB/100 GHz, the effective SNR is maintained at approximately 13 dB over the entire band of the idler light. By setting an appropriate slope to the signal level of incident WDM signal light in the application example, it is confirmed that the transmission performance is improved more than the maximum effective SNR (11.3 dB) in FIG. 15.

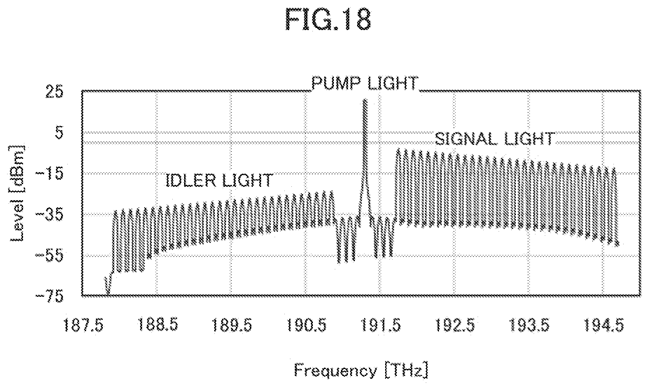

FIG. 18 illustrates the entire spectrum of light involved in the wavelength conversion process when a predetermined slope is set to the input WDM signal light. In this example, a slope of 0.32 dB/100 GHz is set to the input WDM signal light, to lower the signal level in a direction away from the wave length of the pump light. As a result, the ratio of FWM noise is reduced by the idler light in the vicinity of the wavelength of the pump light, and FWM_SNR is improved. The average effective SNR of the entire idler light is improved and the transmission performance is improved.

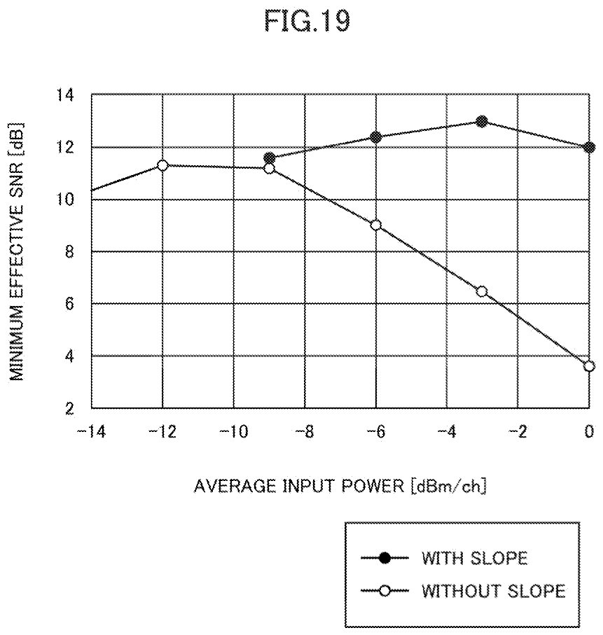

FIG. 19 is a diagram illustrating an effect of the embodiment. The horizontal axis represents the average input power per channel, and the vertical axis represents the minimum effective SNR. The minimum effective SNR represents a minimum effective SNR of the entire idler light. The minimum effective SNR of the comparative example in which no slope is set to the incident WDM signal light is indicated by white circles. The minimum effective SNR when a predetermined slope is set to the incident WDM signal light in the application example is indicated by black circles.

In the case where the wavelength-loss characteristic is not controlled, for example, in the case where the slope is not set to the incident WDM signal light, the effective SNR cannot be improved even if the average input power is increased, and the effective SNR is rather deteriorated. This is because, as described above, by increasing the power of the entire incident WDM signal light, FWM noise increases and FWM_SNR decreases. In contrast to that, by setting a predetermined slope to the incident WDM signal light in the embodiment, the power of the entire incident WDM signal light can be increased and the effective SNR is improved. It is confirmed that the transmission performance is improved in an optical transmission system using wavelength conversion.

As above, the embodiments have been described based on specific configuration examples; note that the present disclosure is not limited to the embodiments described above. The “slope control” of the signal level is an example, and another wavelength-loss characteristic control for maintaining the effective SNR over the wavelength band of the converted light (idler light) may be executed. For the slope control of the power spectrum of the WDM signal light, a power adjustment or variable correction optical filter function such as a gain equalizer or a wavelength shaper may be used, instead of the pre-emphasis function of the transmitter 125 of the transponder or the attenuation function of the WSS. The wavelength converter simply needs to include at least a nonlinear optical medium and an optical filter for extracting idler light, and a pump light source, a multiplexer, an optical amplifier, and the like may be provided outside the wavelength converter. In any of these configurations, by controlling the wavelength-loss characteristic of the WDM signal light incident on a nonlinear optical medium, the effective SNR can be maintained high over the entire wavelength band of the idler light, and the transmission performance can be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission system comprising:
a WDM transmission device configured to output WDM signal light including rays of a plurality of wavelengths;
a wavelength converter configured to convert the WDM signal light into converted light in a different wavelength band; and
a processor configured to control a signal level of the WDM signal light incident on the wavelength converter,
wherein the processor controls the signal level of the WDM signal light so as to make the signal level of the WDM signal light decrease in a direction away from a wavelength of pump light used in the wavelength converter.

2. The optical transmission system as claimed in claim 1, wherein the processor controls output adjustment mechanisms of a plurality of transmitters connected to the WDM transmission device, to control the signal level of the WDM signal light.

3. The optical transmission system as claimed in claim 1, wherein the processor controls a power adjustment mechanism of the WDM transmission device, to control the signal level of the WDM signal light.

4. The optical transmission system as claimed in claim 3, wherein the processor controls an attenuator of a wavelength selective switch of the WDM transmission device, to control the signal level of the WDM signal light.

5. The optical transmission system as claimed in claim 1, wherein the wavelength converter includes an optical amplifier configured to amplify the converted light, and
wherein the processor controls the signal level of the WDM signal light such that an effective signal-to-noise ratio obtained by combining a signal-to-noise ratio with respect to noise generated in a wavelength conversion process and a signal-to-noise ratio with respect to spontaneous emission amplification noise of the optical amplifier becomes highest over an entire wavelength band of the converted light.

6. The optical transmission system as claimed in claim 5, wherein the wavelength converter further includes a correction filter to set a slope opposite to a slope in a wavelength direction set to the signal level of the WDM signal light, to the converted light.

7. A wavelength converter comprising:
a pump light source configured to emit pump light;
a nonlinear optical medium on which the pump light and WDM signal light including a plurality of wavelengths are incident; and
an optical filter configured to extract converted light having a wavelength different from wavelengths of the pump light and the WDM signal light, from light emitted from the nonlinear optical medium,
wherein a signal level of the WDM signal light incident on the nonlinear optical medium is controlled to decrease in a direction away from a wavelength of the pump light.

8. The wavelength converter as claimed in claim 7, further comprising:
an optical monitor configured to monitor the converted light output from the optical filter;
a processor into which a monitoring result of the optical monitor is input; and
an input power adjustment mechanism configured to adjust the signal level of the WDM signal light incident on the nonlinear optical medium,
wherein the processor controls the input power adjustment mechanism based on the monitoring result of the optical monitor, to control the signal level of the WDM signal light.

9. The wavelength converter as claimed in claim 8, wherein the processor calculates a signal-to-noise ratio for each wavelength included in the converted light from the monitoring result, and controls the signal level of the WDM signal light so as to make the WDM signal light have a slope opposite to a slope of a signal-to-noise ratio of the converted light in a wavelength direction.

10. An optical transmission device comprising:
a WDM transmission device configured to output WDM signal light including rays of a plurality of wavelengths to a wavelength converter;
a memory configured to store channel configuration information on the WDM signal light, and control information for controlling a signal level of the WDM signal light; and
a processor configured to control, based on the channel configuration information and the control information, the signal level of the WDM signal light so as to make the signal level of the WDM signal light decrease in a direction away from a wavelength of pump light used in the wavelength converter.

11. The optical transmission device as claimed in claim 10, wherein the processor controls output adjustment mechanisms of a plurality of transmitters connected to the WDM transmission device or a power adjustment mechanism of the WDM transmission device, to control the signal level of the WDM signal light.
